(19) United States
(12) Patent Application Publication
(10) Pub. No.: US 2015/0343453 A1
(43) Pub. Date: Dec. 3, 2015

(54) FLUID ENERGY MEDIA MILL SYSTEM AND METHOD

(71) Applicant: David A. Czekai, Spring City, PA (US)

(72) Inventor: David A. Czekai, Spring City, PA (US)

(73) Assignee: NanoCentrix L.L.C., Spring City, PA (US)

(21) Appl. No.: 14/720,852

(22) Filed: May 25, 2015

Related U.S. Application Data
(60) Provisional application No. 62/004,124, filed on May 28, 2014.

(51) Int. Cl. B02C 19/06; B02C 17/18; B02C 17/16

(52) U.S. Cl. CPC B02C 19/061; B02C 17/161; B02C 17/1815

(57) ABSTRACT

A system for wet milling or dry milling at least one material. The system includes a milling apparatus and at least one milling medium. The milling apparatus includes a chamber, at least one inlet, at least one outlet and a fluid pump. The fluid pump facilitates concomitant flow of the milling medium and material to be milled within the milling chamber to effect milling of the material.

### FIELD OF THE INVENTION

The invention relates generally to a media milling apparatus for the production of fine grade particulate substances. More specifically, the invention relates to the use of fluid energy as the energy source to effect milling of materials within a media mill apparatus.

### BACKGROUND OF THE INVENTION

Particle size reduction via wet and dry milling techniques represents an important manufacturing approach for many industrial applications, including pharmaceuticals, chemicals, paints, inks, minerals, agrochemicals, foods, rubber, energy, electronics, and biotechnology. In practice, it is accepted that finer particle size can be achieved with wet milling than by dry grinding techniques. Wet milling techniques such as ball milling or media milling can produce particles less than 1 micron, and in some cases particle sizes less than 100 nm can be achieved. In contrast, dry grinding techniques are generally limited to 10-20 micron particle sizes. Fluid energy jet milling of dry materials has been shown to be capable of achieving particle sizes in the 5-10 micron range.

Dry Milling Processes

Dry milling processes that utilize mechanical impact or shear of materials include jaw crushers, gyratory crushers, impact mills, roll crushers, and shredders. The energy supplied to effect material milling is generally accomplished through transfer of kinetic energy from a drive motor to machine elements that produce impact or shearing forces with materials to be milled. These devices do not incorporate the use of milling media.

Dry milling processes that utilize fluid energy to effect milling of materials include fluid-energy jet mills, such as centrifugal jet mills, opposing jet mills, and fluidized bed jet mills. A detailed description of jet mills is presented by Gossett [Chem. Process. (Chicago), 29(7), 29 (1966)]. In the centrifugal class of jet mills, the fluid energy is admitted in fine high-velocity streams at an angle around a portion or all of the periphery of a grinding and classifying chamber. An example is U.S. Pat. No. 6,789,756 to Beliaysky, herein incorporated by reference. In fluidized-bed jet mills, fluid streams, typically compressed air, convey the particles at high velocity into a chamber where two streams impact upon each other. Particle size reduction in jet mills is generally achieved by high velocity collisions between material particles entrained in high velocity gas stream within the jet mill chamber. By controlling the perturbations occurring within the air vortex, a significant influence on the pulverization process is achieved. Not all particles are completely milled, however, in one circuit. Jet mills often incorporate internal particle classification features to return un-milled particles to the milling chamber. Most of these mills utilize the energy of the flowing gas stream to effect centrifugal classification. Since jet mills generally have no drive motor, there is not the requirement for use of mechanical seals. Jet mills are considered high-energy milling systems, with fluid velocities greater than 10 m/sec. Jet mills do not incorporate the use of milling media to effect particle size reduction of materials and therefore have limited utility in production of material particle size reduction below 5 microns.

Dry milling processes that utilize milling media to effect milling of materials include ball or pebble mills, vibratory mills and attritors. In these mills, collisions of milling media result in shear and impact forces that result in dry material particle size reduction. In ball or pebble mills, the mechanical rotation of the ball mill milling chamber gives rise to gravitational cascading of the milling balls or pebbles that results in shear and impact forces that cause particle size reduction. Ball or pebble mills are generally considered low-energy input milling systems with media flow speeds less than 1 m/sec and are characterized by lengthy milling times, often on the order of several days. Similarly, vibratory mills utilize oscillating vibrations of the milling chamber to cause movement of the milling media to effect particle size reduction. Vibratory mills are generally considered low/medium energy input milling systems with media flow speeds in the range of 1-5 m/sec. Attritors (Union Process Inc.) are a class of stirred media mills that utilize mechanical agitation of milling media by means of a motor-driven mixer within the milling chamber. Attritors are generally considered medium-energy-input systems, with agitator speeds of less than 5 m/sec peripheral velocity.

Wet Milling Processes

Particle size reduction accomplished by wet milling processes includes application of impact and shearing forces delivered by equipment to effect comminution.

Examples of impact mills include high-speed impingement mills. Examples of shearing mills include colloid mills, three-roll mills and high-speed stone mills. These classes of mills do not utilize milling media to effect material particle size reduction and have limited utility in the production of material particle sizes below 5 microns.

Wet milling processes that incorporate the use of milling media include shot mills, ball and pebble mills, sand and bead mills and attritors. The comminution forces utilized in these media mills generally include a combination of impact and shearing forces. Wet media milling processes generally are capable of production of material particle sizes below 5 microns.

Wet milling processes that utilize milling media to effect milling of materials include ball or pebble mills, sand and bead mills, vibratory mills and attritors. Materials to be processes generally exist in a solid or semi-solid state dispersed within a liquid medium. Slurries or dispersions processed within such mills often utilize the addition of polymeric or surfactant stabilizers to promote particle dispersion and stabilization. In these mills, collisions of milling media result in shear and impact forces that result in material particle size reduction. In ball or pebble mills, the mechanical rotation of the ball mill milling chamber gives rise to gravitational cascading of the milling balls or pebbles within the mill that results in shear and impact forces that cause particle size reduction. Ball or pebble mills are generally considered low-energy input milling systems with media flow speeds less than 1 m/sec and are characterized by lengthy milling times, often on the order of several days. Similarly, vibratory mills utilize oscillating vibrations of the milling chamber to cause movement of the milling media to effect particle size reduction. Vibratory mills are generally considered low/medium energy input milling systems with media flow speeds in the range of 1-5 m/sec. Attritors (Union Process Inc.) are a class of stirred media mills that utilize mechanical agitation of milling media by means of a motor-driven mixer within the milling chamber. Attritors are generally considered medium-energy-input systems, with agitator speeds of less than 5 m/sec peripheral velocity. Such low, low-medium and medium energy input systems generally cannot utilize media smaller than 2 mm, since larger media are required to overcome the viscous resistance associated with flow in lower energy systems. As such, these systems generally have limited applicability to very fine milling of materials to particle sizes less about 1 micron.

High-energy wet media mills have in recent years become preferred and widely used for the production of very fine particulate materials less than 1 micron. Indeed, nanotechnology materials have been processed in size ranges below 100 nm using these mills. These media mills typically include a cylindrical vessel housing a vertically or horizontally mounted agitator shaft having shear members extending therefrom. Typically, a dispersion consisting of the product to be milled and a milling media is introduced into the vessel. Rotating the agitator causes the media to impact and shear the product into a finer grade. In traditional prior art mills an agitator shaft is connected through some means to a motor via either a mechanical or magnetic coupling. The agitator shaft is coupled at one point to a milling head and at another point to the motor. In order to prevent the milled product from leaking into the area wherein the drive shaft extends into the milling chamber, seals of some type, e.g., lip seals or mechanical seals, are used. Typically, lip seals have a short lifespan and have limited utility in commercial mills. Mechanical seals are broadly used in commercial mills, although there are numerous disadvantages. Such disadvantages include the requirement for a lubricant that can cause product contamination, difficulty in cleaning and sterilization due to complex designs, seal failure and associated process shutdowns and limitations in operating speeds and milling chamber pressures. Seal failure can occur due to heat generation, chemical attack, rotational shaft deflections, vibration, seal fluid vaporization or crystallization.

Wet high-energy media mills that utilize magnetic coupling of the agitator to a drive motor solve many of the problems associated with the use of mechanical seals. However, such magnetically-coupled mills generally are limited to small-scale equipment with limited speed capabilities due to the inherent limitations of magnetic coupling technology.

Further disadvantages of high-energy media mills include the use of complex agitation systems, drive systems and cooling systems which result in high fabrication costs. Due to milling chamber pressure limitations associated with mechanical seals, milling pressures must be maintained at relatively low levels to avoid seal failure. Such low pressures limit product flow rate through mill and ability to dissipate heat generated during milling. Also, mill speeds and related milling efficiencies are limited by mechanical drive systems such as bearings, mechanical seals, and milling chamber cooling efficiencies. Due to limitations of mill agitator speeds and limited media separator screen surface area, the use of smaller milling media is limited in such designs, such media being increasingly desirable for preparation of very fine particulate products

### SUMMARY OF THE INVENTION

Provided in accordance with an exemplary embodiment of the present invention is fluid energy media mill for milling a substantially particulate solid material. The fluid energy media mill includes at least one hollow milling chamber 101 having a top 108, a bottom 111, and a side wall 114. Milling media is disposed in the hollow milling chamber 101. The milling chamber 101 has at least one inlet 102 along its side wall 114. The inlet 102 is configured to introduce the material into the hollow milling chamber 101 and promote a flow (vortex or turbulent) of the material and milling medium within the hollow milling chamber 101. The milling chamber 101 has an outlet 103 connected to the hollow milling chamber 101 to which a pump 104 is in fluid communication with the inlet 102 for introducing material through the hollow milling chamber 101.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a schematic drawing of an exemplary fluid energy media mill system according to an embodiment of the invention;

FIG. 2A is a schematic, radial cross sectional view of an exemplary embodiment of a milling chamber;

FIG. 2B is an enlarged, partial schematic of a radial cross sectional view of an inlet according to an exemplary embodiment of a milling chamber

FIG. 3 is a schematic isometric view of a recirculating fluid energy media mill according to an embodiment of the invention;

FIG. 4 is a schematic isometric view of a parallel fed multiple milling chambered fluid energy media mill according to an embodiment of the invention; and

FIG. 5 is a schematic drawing of another exemplary fluid energy media mill system according to an embodiment of the invention.

### DETAILED DESCRIPTION OF THE INVENTION

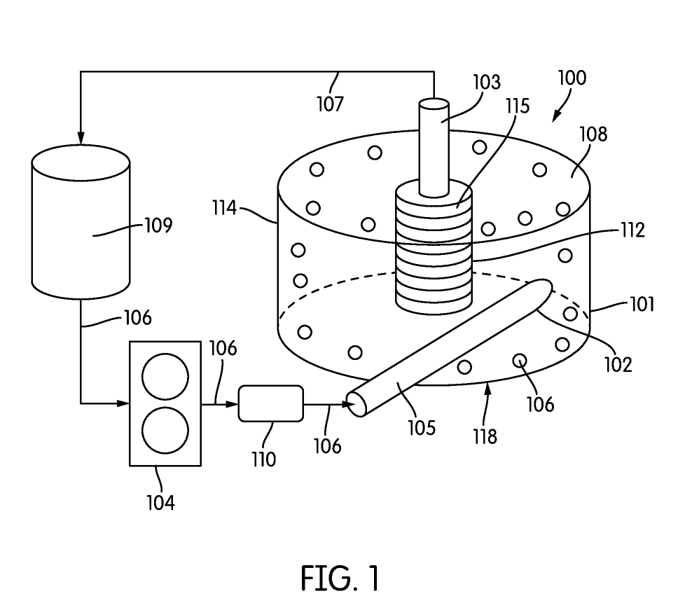

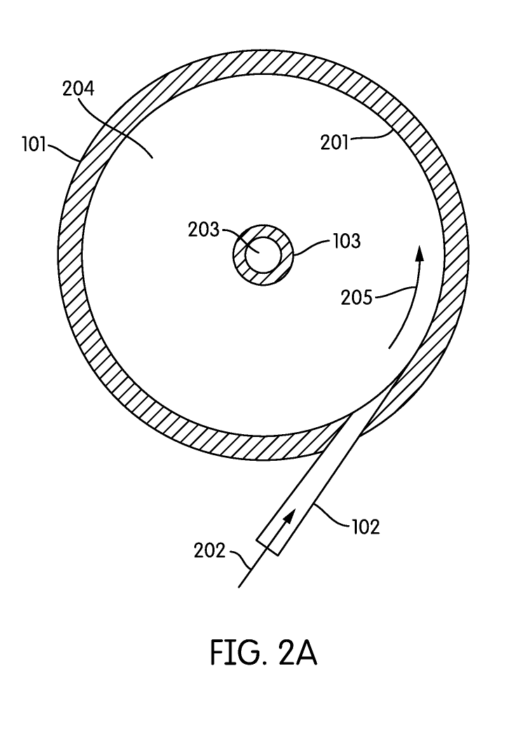

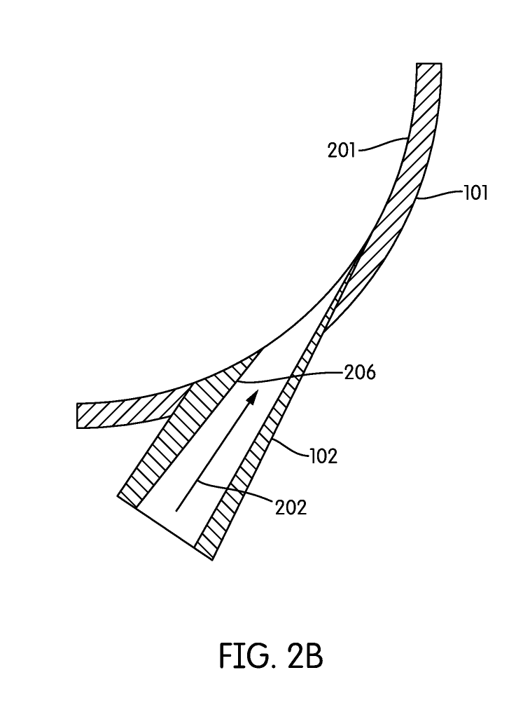

Referring now to FIGS. 1, 2A and 2B is a fluid energy mill system 100, constructed and operative in accordance with an exemplary embodiment of the present invention. Mill system 100 includes milling chamber 101 having a side wall 114, a top 108, and a bottom 111 defining therein a milling chamber interior 204. Top 108 is integral with side wall 114 or is a separate component fixedly and releaseably attached to side wall 114. Mill chamber interior is defined to induce turbulent or vortex flow of fluidized material injected therein. Mill components, such as top 108, bottom 118, and side wall 114 are constructed of materials suitable for exposure to various aqueous and non-aqueous liquids as well as materials such as active pharmaceutical ingredients including drugs, biologic, inorganic, organic, caustic, or acidic. In exemplary embodiments, milling chamber interior is constructed of high-grade, non-porous stainless steel and top 108 is constructed of a clear material, such as acrylic or glass, in order to observe whether the appropriate vortex flow of fluidized material has been generated in the milling chamber.

In an exemplary embodiment, milling chamber 101 is generally cylindrical in shape and has a volume of about 100, 50, 25, 10, 5, 1, 0.5 or 0.1 liters. The ratio of milling chamber height to diameter is in the range of about 100, 10, 5, 1, 0.2, 0.1, 0.01; consistent with the principle that a larger height/diameter ratio favors centrifugal separation of media for a given volume chamber.

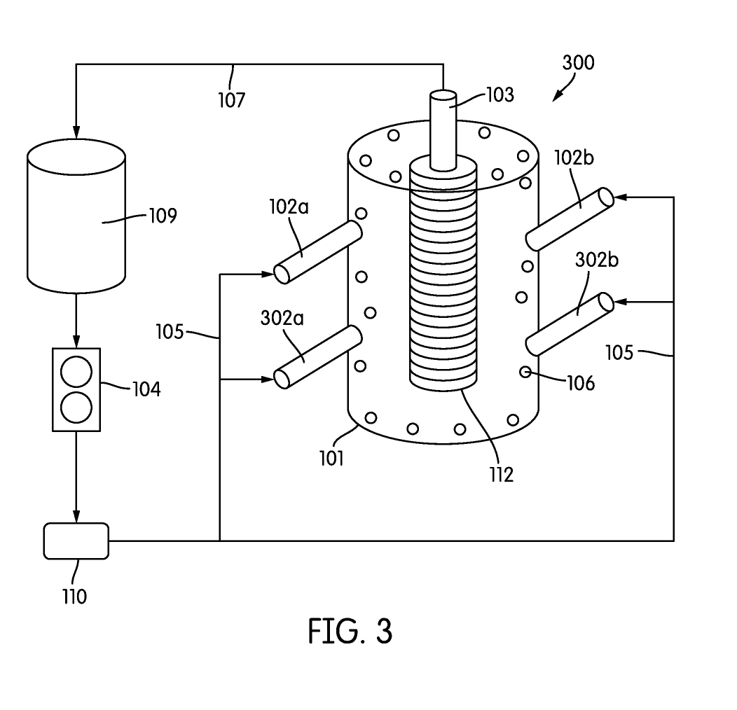

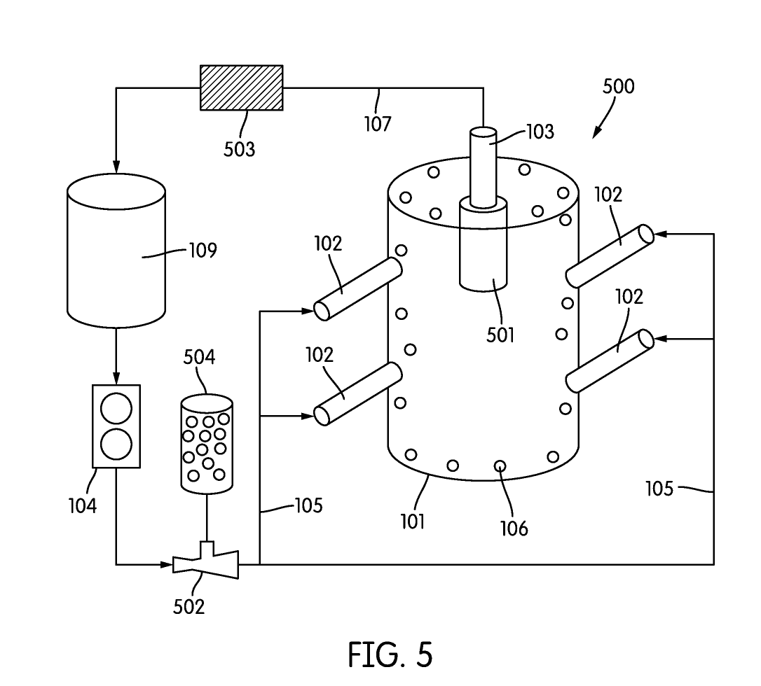

On side wall 114 is at least one fluid inlet 102 having an inlet conduit 105 releaseably coupled thereto. Fluid inlet 102 is in fluid communication with milling chamber interior 204 as shown in more detail in FIG. 2A. Contained within milling chamber 101 are milling medium 106 shown as small spheres in FIG. 1. Releaseably coupled to top 108 and mounted coaxial to milling chamber 101 is outlet 103. Outlet 103, on one end, extends into milling chamber interior 204 and has releaseably attached thereto discharge collector 115. Discharge collector 115 is a screen 112 as shown in FIG. 3 or vortex finder 501 as shown in FIG. 5. In an alternative embodiment, inner wall 201 of milling chamber 101 contains shear members (not shown) such as a peg, vanes or other geometries that would result in more energetic collisions of milling media to provide flow disruption which may improve comminution effects. The shear members would be of sufficient size and shape so that vortex flow is retained but with localized perturbations in the flow due to the shear members.

In the embodiments where discharge member 115 is a screen 112, screen 112 may be of any geometry sufficient to prevent the uptake of milling media 106 into outlet 103. Screen 112 may be constructed from a variety of materials. The screen is constructed with a screen opening size and overall surface area so that milling media 106 are not taken up through outlet 103 while the fluidized material is allowed to pass.

In an alternative embodiment, discharge collector 115 is a centrifugal separator such as a vortex finder. A vortex finder is commonly used in hydrocylones to promote centrifugal separation of solid particles from liquids (reference: Solid-Liquid Separations, L. Svarovsky, 4^{th} edition, 2000, chapter 6: Hydrocyclones). A vortex finder facilitates separation of solids from a liquid slurry as is understood by one of ordinary skill in the art. The vortex finder as discharge collector 501 protrudes into milling chamber interior 204 to prevent immediate escape of the milling media introduced from inlet 102, and gives the milling media the opportunity to become entrained in vortex flow and be centrifuged to the chamber wall. In this configuration, the milling media once charged establishes vortex flow with the fluid material and the milling media is retained in the milling chamber due to centrifugal separation, but the fluid material is removed through the vortex finder 501 and outlet 103.

Outlet conduit 107 is releaseably coupled to the other end of outlet 103 Outlet conduit 107, according to the embodiment shown in FIG.1, is in fluid communication with material reservoir 109 and pump 104. According to the embodiment shown in FIG. 1, pump 104 is in fluid communication with inlet conduit 105, which is attached to inlet 102. Also shown in the embodiment of FIG. 1 is a heat exchanger 110 coupled to inlet conduit 105. According to this embodiment, the components of the mill system are in-line with each other to form a continuous circulating loop. In alternative embodiments, certain components of the mill may not be in-line, but attached thereto via a valve system as shown and described in more detail in FIG. 5. The individual components of mill system 100 are in fluid communication with one another, and each component is envisioned to be releaseably or fixedly coupled to one another.

Shown in FIG. 2A is a schematic, radial cross sectional view of an exemplary embodiment of milling chamber 101. Shown in FIG. 2, milling chamber interior 204 is substantially circular in shape. Inlet 102 is affixed to milling chamber 101 so that the fluidized material that enters milling chamber interior has a substantially tangential flow path (shown by the directional arrow labeled 205) to milling chamber inner wall 201.

Operation of fluid energy mill 100 includes introducing fluidized material into milling chamber 101 through inlet 102, mixing with milling media 106, disposed therein, so as to give rise to a vortex fluid flow (shown by the directional arrow generally referenced as 205 in FIG. 2A). A vortex induces milling medium 106 and fluidized material to undergo comminution. As fluidized material accumulates and as the material is milled within milling chamber 101, comminuted materials and fluid are extracted or discharged via outlet 103 extending into milling chamber interior 204 having releaseably attached thereto discharge collector 115. Outlet 103 is axially disposed to milling chamber 101 and the fluidized material travels via material outlet flow path 203 as shown in FIG. 2A. In this manner, milling media 106 remain substantially in milling chamber interior 204 under centrifugal forces while the fluidized milled material is harvested or, according to exemplary embodiments, is re-circulated via pump 104 back into milling chamber 104 via inlet 102.

A high degree of comminution and a narrow range of the particle size of the material to be milled is achieved with sufficient vortex flow within milling chamber interior 204. FIG. 2B shows an exemplary inlet 102 shown with a tapered nozzle 206 where the tapered end of inlet 102 is in fluid communication with milling chamber interior 204. Tapered nozzle 206 is configured to induce vortex flow of the fluidized material and milling medium 106 in milling chamber interior 204. Furthermore, it will be appreciated to persons skilled in the art that the flow rate and velocity of fluidized material introduced into milling chamber 101 through inlet 102 are factors in determining the frequency of controlled perturbation within the vortex. In addition, for a given flow rate, the greater the degree of tapering of tapered nozzle 206, the greater the fluid velocity and associated centrifugal vortex, and consequently, the greater communition with milling media 106. Controlling the vortex flow of the fluidized material through inlet 102 and the flow of recycled partially milled fluidized material back through inlet 102, influences the resulting particle size of the milled material. In addition, the viscosity and density of the fluid used to render the material to be milled in suspension influences the flow characteristics of milling media and material fluid within milling chamber 101. For example, a higher material fluid viscosity results in more viscous drag on the media in the radial direction and tends to force media to the outlet, which is undesirable. Higher material fluid velocities promote greater centrifugal separation of the milling media and can counteract the viscous drag effect. Also, milling media size and density affect milling media centrifugation. Higher density and larger size promote better media centrifugation. Media centrifugation is also a function of the material fluid density. A higher ratio of milling media density to material fluid density promotes good milling media centrifugation.

In exemplary embodiments, the fluid portion of the fluidized material is an aqueous fluid, such a water or sucrose solution or stabilizer solution. In other embodiments, the fluid is compressed gas or a non-aqueous fluid depending on the solubility of the material to be milled. Introduction of the material is exemplified with reference to FIG. 1, where material is added via a material reservoir 109 to a fluid-charge mill system. In an embodiment, dry powdered material having a particle size measured in the microns (i.e., meloxicam in Examples 1-2) was contained in a material reservoir that is not in-line with the mill system. The material from the reservoir can be slowly added to a stabilizer solution that is already circulating through the mill system to form a recirculating slurry. In an alternative embodiment, a slurry of fluidized material is prepared separately and prior to establishing circulation through the mill system and is used to charge the system.

According to an embodiment, the mill is pre-charged with a fluidized material, such as a drug substance suspended in water or a stabilizer solution. The volume of fluidized material is a pre-determined volume depending on the amount of material to be milled, the volume of the milling chamber, the capacity of the pump, and volume of the associated piping. According to this embodiment, the milling media is pre-charged to the milling chamber that is in-line with the other components of the mil as shown in FIG. 1. In an embodiment where the material reservoir and media feed hopper 504 are not in-line with the fluid energy mill system, material and milling media are added via pressure differential created by the fluid flow within the mill system (similar to the function an eductor using the Venturi principle) because the mill system is under closed, circulating fluid pressure flow. Accordingly, when a valve from the material reservoir is opened, the fluid flow creates a small vacuum that draws the dry powdered material, milling media or fluidized material from the material reservoir. Once introduced into the mill system, the pump provides circulation to pressure feed the fluidized material through the mill.

The fluid force or momentum flux generated within the milling chamber contributes to the comminution forces required to effect milling of the material fluid during concomitant flow with milling media. The fluid force is a function of fluid flow rate and velocity. Fluid flow rates can range from 1 to 1000 liters/minute. Fluid velocities can range from 1 to 1000 meters/second. Various system parameters influence the fluid force generated within the milling chamber. These include the pump type and size, nozzle geometry, number of inlet nozzles, fluid viscosity, fluid density and other parameters commonly understood to impact fluid flow dynamics. Suitable pumps include positive displacement pumps, centrifugal pumps or other pumps capable of conveying fluids over a flow rate range of 1 to 1000 liters/minute with a pressure range over 1 to 10,000 psi.

In alternative embodiments, such as shown in FIG. 3, material reservoir 109 is in-line with the fluid energy mill system. In this embodiment, the material is prepared as a slurry in a predetermined fixed volume. Once the mill has run, a valve system (not shown) is incorporated to collect the milled material in the material reservoir 109. Although a fixed fluid volume is exemplified, a continuous feed liquid volume is also contemplated.

Also shown in FIG. 3 is an embodiment of a re-circulating fluid energy mill 300 having multiple inlets 102a, 102b, 304a, and 304b. It is envisioned that larger quantities of material to be milled require a large volume, milling chamber. Because of the size, multiple inlets and multiple inlet conduits provide fluidized material into milling chamber 101. According to an embodiment where the milling chamber is a cylinder, at least one inlet 102a and a second inlet 102b are disposed along the same radial plane of the hollow milling chamber 101, at 180° from one another, but positioned such to encourage the same directional flow of the fluidized material within the milling chamber interior. Alternatively, inlets 102a and 102b may be positioned at 0° and 30° or at 0° and 60° or at 0° and 90° or at 0° and 120° or at 0° and 150° or at 0° and 180° from each other. In yet further embodiments, inlets 102a and 302a are disposed at different heights along the cylindrical hollow milling chamber but are again oriented such that the same rotational flow of the fluidized material is induced within the interior of the milling chamber. In yet another embodiment, inlets 102a, 102b, 302a and 302b are positioned at various points along the exterior of the milling chamber such that each material flow path from the multiple inlets contributes to the formation of a fluid vortex within the interior of the milling chamber.

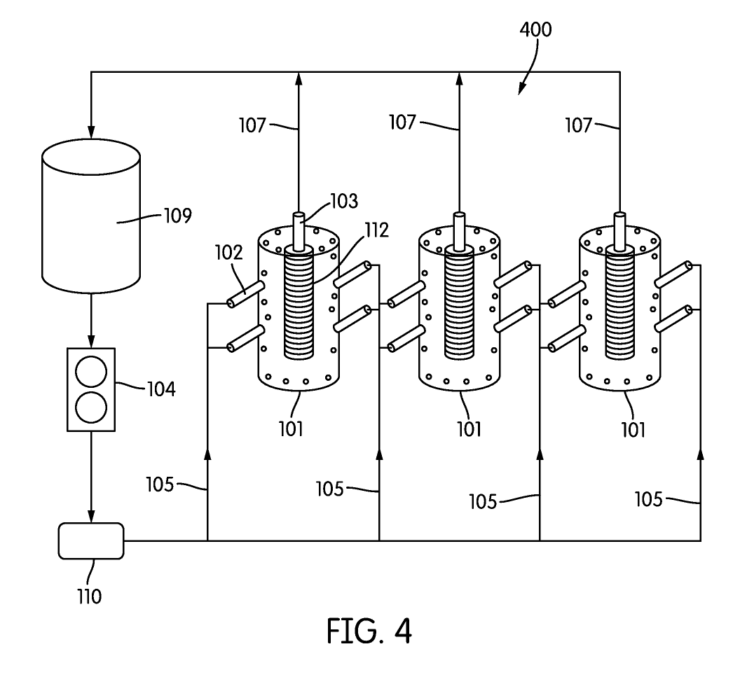

FIG. 4 illustrates a schematic isometric view of a fluid energy media milling system 400 which includes the parallel feed of fluidized material into multiple milling chambers. The use of a parallel feed process facilitates direct scale-up for processing larger batch sizes without increasing milling time by maintaining mill geometry for each milling chamber unit and increasing the number of units while maintaining the flow rate and velocity for each unit. This approach allows mill scale-up by avoiding increasing the diameter that leads to a decrease in milling media centrifugation. Alternatively, this approach allows mill scale-up by avoiding an increase in mill length that leads to an unacceptable increase in operating milling chamber back-pressure.

The amount of milling medium 106 present in the mill is predicated upon a variety of factors including the volume of the milling chamber, the material fluid flow rate, the material fluid velocity and physical characteristics of the fluid such as viscosity, density and feed size of material to be milled. In addition, the amount of milling media is also predicated on the milling media properties, including size, density, geometry and hardness. Typically, the milling media volumetric charge ranges from 1 to 99% of the working volume of the milling chamber, which includes the milling chamber volume less the volume of the discharge collector.

FIG. 5 illustrates a schematic isometric view of a fluid energy media milling system 500. In this embodiment the material to be milled is fluidized in water or an aqueous stabilizer solution or an organic material. The mill system is pre-charged with the fluidized material and circulates in the closed-loop mill system. Media is charged in media feed hopper 504 and slowly added to an inlet conduit via educator 502 or valve at a pressure differential sufficient to allow milling media to be entrained in the material fluid flow (not shown). In this embodiment, the gradual addition of the media into the pre-circulating fluidized material allows for continuous vortex formation and overcomes the energy needed to induce vortex formation when media is contained solely within the media chamber. Centrifugal forces from the vortex flow within the milling chamber keep most of the milling media from escaping the milling chamber via outlet 103. A vortex finder 501 disposed on the end of outlet 103 protruding into the interior of the milling chamber also prevents media from escaping through outlet 103. It is also envisioned, according to this embodiment, that if media were to escape milling chamber, a media safety screen would be placed in-line and upstream of the material reservoir or pump so as not to contaminate the reservoir or damage the pump mechanics.

### EXAMPLES

The following examples illustrate embodiments of the invention described herein.

### Example 1

The purpose of this example was to demonstrate the utility of the invention to effect particle size reduction in the preparation of a nanoparticulate dispersion of meloxicam using yttria-stabilized zirconia milling media.

5.555 kg of aqueous slurry of 5% meloxicam (AMSA S.P.A.), 1% Povidone K30 (Spectrum Chemical Mfg. Corp.) and 0.05% Docusate Sodium (Spectrum Chemical Mfg. Corp.) was charged to the reservoir of the system illustrated in FIG. 3. 435 cc of yttria-stabilized zirconia milling media (0.5 mm, Tosoh) was charged to the milling chamber. The milling chamber comprised a cylindrical vessel with 10 cm diameter×10 cm height and 800 cc working volume. A 200 micron cylindrical slotted screen, 4 cm diameter×5 cm height, was attached to the mill outlet and inserted into the milling chamber. Four tangentially mounted inlets were attached to the milling chamber, each equipped with a 2.5 mm tapered nozzle. 2 inlets were mounted at a 3:00 and 9:00 position, 2.5 cm from the milling chamber base, and 2 inlets were mounted at a 6:00 and 12:00 position, 7.5 cm from the milling chamber base. The slurry was circulated from the reservoir by means of a positive displacement rotary gear pump (Oberdorfer 2 hp, model N994RH, 1725 rpm), through a water-cooled heat exchanger into the milling chamber and returned to the reservoir in a closed-loop recirculation process. A recirculation flow rate of 32-34 l/min was maintained over the course of an 8-hour milling process. Inlet pressure to the milling chamber was maintained in the range of 108-112 psi. Temperature was maintained in the range of 5-25 C.

Samples were withdrawn for particle size analysis at time 0, 1, 2, 4, and 8 hours (Horiba LA950 particle size analyzer, Horiba Instruments, Irvine, Calif.). The results are shown in Table 1. In the table below, the value for D50 is the particle size below which 50% of the meloxicam particles fall. Similarly, D90 is the particle size below which 90% of the meloxicam particles fall. The results demonstrate rapid particle size reduction of the meloxicam particles.

TABLE 1

| Milling Time (hr) | Mean (nm) | D50 (nm) | D90 (nm) |
|---|---|---|---|
| 0 | 20,249 | 18,864 | 32,537 |
| 1 | 2,091 | 1,633 | 5,194 |
| 2 | 1,045 | 751 | 2,577 |
| 4 | 542 | 155 | 1,441 |
| 8 | 253 | 120 | 832 |

### Example 2

The purpose of this example was to demonstrate the utility of invention to effect particle size reduction in the preparation of a nanoparticulate dispersion of meloxicam using glass media.

5.555 kg of aqueous slurry of 5% meloxicam (AMSA S.P.A.), 1% Povidone K30 (Spectrum Chemical Mfg. Corp.) and 0.05% Docusate Sodium (Spectrum Chemical Mfg. Corp.) was charged to the reservoir of the system illustrated in FIG. 3. 435 cc of glass milling media (0.5-0.75 mm Type S Glass, Ceroglass Technologies Inc.) was charged to the milling chamber. The milling chamber comprised a cylindrical vessel with 10 mm diameter×10 mm height and 800 cc working volume. A 200 micron cylindrical slotted screen, 4 mm diameter×5 mm height, was attached to the mill outlet and inserted into the milling chamber. Four tangentially mounted inlets were attached to the milling chamber, each equipped with a 2.5 mm tapered nozzle. 2 inlets were mounted at a 3:00 and 9:00 position, 2.5 cm from the milling chamber base, and 2 inlets were mounted at a 6:00 and 12:00 position, 7.5 cm from the milling chamber base. The slurry was circulated from the reservoir by means of a positive displacement rotary gear pump (Oberdorfer 2 hp, model N994RH, 1725 rpm), through a water-cooled heat exchanger into the milling chamber and returned to the reservoir in a closed-loop recirculation process. A recirculation flow rate of 31-33 l/min was maintained over the course of an 8-hour milling process. Inlet pressure to the milling chamber was maintained in the range of 102-110 psi. Temperature was maintained in the range of 5-25 C.

Samples were withdrawn for particle size analysis at time 0, 1, 2, 4, and 8 hours (Horiba LA950 particle size analyzer, Horiba Instruments, Irvine, Calif.). The results are shown in Table 2. In the table below, the value for D50 is the particle size below which 50% of the meloxicam particles fall. Similarly, D90 is the particle size below which 90% of the meloxicam particles fall. The results demonstrate rapid particle size reduction of the meloxicam particles.

TABLE 2

| Milling Time (hr) | Mean (nm) | D50 (nm) | D90 (nm) |
|---|---|---|---|
| 0 | 20,310 | 19,141 | 31,816 |
| 1 | 2,800 | 2,526 | 5,585 |
| 2 | 2,379 | 1,900 | 5,374 |
| 4 | 806 | 190 | 2,185 |
| 8 | 433 | 126 | 1,280 |

### Example 3

The purpose of this example was to demonstrate the utility of the invention to conduct milling without the use of a media separator screen.

7 kg of an aqueous 50% sucrose solution was charged to the reservoir of the system illustrated in FIG. 5. 300 cc of yttria-stabilized zirconia milling media (0.5 mm, Tosoh) was charged to the media feed hopper. The milling chamber comprised a cylindrical vessel with 10 cm diameter×10 cm height and 800 cc working volume. A vortex finder, 16 mm diameter×25 mm height, was attached to the mill outlet and inserted into the milling chamber. Four tangentially mounted inlets were attached to the milling chamber, each equipped with a 2.5 mm tapered nozzle. 2 inlets were mounted at a 3:00 and 9:00 position, 2.5 cm from the milling chamber base, and 2 inlets were mounted at a 6:00 and 12:00 position, 7.5 cm from the milling chamber base. The sucrose solution was circulated from the reservoir by means of a positive displacement rotary gear pump (Oberdorfer 2 hp, model N994RH, 1725 rpm), into the milling chamber and returned to the reservoir in a closed-loop recirculation process.

Once steady state recirculation flow was established, the milling media was fed over the course of 30 minutes from the media feed hopper, through the eductor, into the milling chamber. During the course of media feed to the milling chamber, system pressure decreased from 156 psi to 136 psi, system temperature increased from 17 C to 37 C, and system flow rate increased from 33 to 35 l/min.

Visual examination through a clear Plexiglas cover on the milling chamber indicated high speed vortex flow of the media and sucrose solution mixture, confirming the development of a high-energy milling condition.

After 15 minutes of recirculation, the process was stopped and the media safety screen was disassembled to measure the amount of media that escaped the mill. It was found that <1 cc of media escaped the mill during this example, indicating good media retention within the mill.

### Example 4

The purpose of this example was to demonstrate the utility of the invention to conduct milling without the use of a media separator screen.

This example was a replication of Example 3, but included the following variations:

The milling chamber comprised a cylindrical milling chamber with a 20 cm diameter, 5 cm height and a 1600 cc working volume. Four tangentially mounted inlets were attached to the milling chamber, each equipped with a 2.5 mm tapered nozzle. The inlets were mounted at a 12:00, 3:00, 6:00 and 9:00 positions, 2.5 cm from the milling chamber base.

During the course of media feed to the milling chamber, system pressure remained constant at approximately 150 psi, system temperature increased from 15 C to 35 C, and system flow rate increased from 35 to 36 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that 150 cc of media escaped the mill during this example, indicating poor media retention within the mill.

### Example 5

The purpose of this example was to demonstrate the utility of the invention to conduct milling without the use of a media separator screen.

This example was a replication of Example 3, but included the following variations:

The milling chamber comprised a cylindrical milling chamber with a 10 cm diameter, 5 cm height and a 400 cc working volume. Two tangentially mounted inlets were attached to the milling chamber, each equipped with a 3.5 mm tapered nozzle, mounted at a 3:00 and 9:00 position, 2.5 cm from the milling chamber base.

200 cc of yttria-stabilized zirconia milling media (0.5 mm, Tosoh) was charged to the media feed hopper.

During the course of media feed to the milling chamber, system pressure decreased from 160 psi to 120 psi, system temperature increased from 21 C to 43 C, and system flow rate increased from 36 to 37 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that <1 cc of media escaped the mill during this example, indicating good media retention within the mill.

### Example 6

The purpose of this example was to demonstrate the utility of the invention to conduct milling without the use of a media separator screen.

This example was replication of Example 3, but included the following variations:

400 cc of yttria-stabilized zirconia milling media (0.5 mm, Toshoh) was charged to the media feed hopper.

Four tangentially mounted inlets were attached to the milling chamber, each equipped with a 9 mm untapered nozzle. 2 inlets were mounted at a 3:00 and 9:00 position, 2.5 cm from the milling chamber base, and 2 inlets were mounted at a 6:00 and 12:00 position, 7.5 cm from the milling chamber base.

The sucrose solution was circulated from the reservoir by means of a centrifugal pump (Berkeley 1.5 hp, model S39522, 3450 rpm), into the milling chamber and returned to the reservoir in a closed-loop recirculation process.

During the course of media feed to the milling chamber, system pressure decreased from 44 psi to 23 psi, system temperature increased from 15 C to 44 C, and system flow rate increased from 69 to 117 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that <1 cc of media escaped the mill during this example, indicating good media retention within the mill.

### Example 7

The purpose of this example was to demonstrate the utility of the invention to conduct milling without the use of a media separator screen.

This example was replication of Example 6, but included the following variations:

No vortex finder was attached to the milling chamber outlet.

During the course of media feed to the milling chamber, system pressure decreased from 35 psi to 6 psi, system temperature increased from 9 C to 31 C, and system flow rate increased from 50 to 86 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that 200 cc of media escaped the mill during this example, indicating poor media retention within the mill.

### Example 8

The purpose of this example was to demonstrate the utility of the invention to conduct milling without the use of a media separator screen.

This example was replication of Example 5, but included the following variations:

125 cc of yttria-stabilized zirconia milling media (0.5 mm, Toshoh) was charged to the media feed hopper.

Two tangentially mounted inlets were attached to the milling chamber, each equipped with a 5.5 mm tapered nozzle, mounted at a 3:00 and 9:00 position, 2.5 cm from the milling chamber base.

The sucrose solution was circulated from the reservoir by means of a centrifugal pump (Berkeley 1.5 hp, model S39522, 3450 rpm), into the milling chamber and returned to the reservoir in a closed-loop recirculation process.

During the course of media feed to the milling chamber, system pressure decreased from 55 psi to 50 psi, system temperature increased from 10 C to 40 C, and system flow rate increased from 37 to 54 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that <1 cc of media escaped the mill during this example, indicating good media retention within the mill.

### Example 9

The purpose of this example was to demonstrate the utility of the invention to conduct milling without the use of a media separator screen.

This example was replication of Example 4, but included the following variations:

300 cc of glass milling media (0.5-0.75 mm Type S Glass, Ceroglass Technologies Inc.) was charged to the media feed hopper.

Four tangentially mounted inlets were attached to the milling chamber, each equipped with a 5.5 mm tapered nozzle.

The sucrose solution was circulated from the reservoir by means of a centrifugal pump (Berkeley 1.5 hp, model S39522, 3450 rpm), into the milling chamber and returned to the reservoir in a closed-loop recirculation process.

During the course of media feed to the milling chamber, system pressure decreased from 44 psi to 34 psi, system temperature increased from 21 C to 44 C, and system flow rate increased from 65 to 69 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that 125 cc of media escaped the mill during this example, indicating poor media retention within the mill.

### Example 10

The purpose of this example was to demonstrate the utility of the invention to conduct milling without the use of a media separator screen.

This example was replication of Example 9, but included the following variations:

Water was used in place of 50% sucrose solution

During the course of media feed to the milling chamber, system pressure decreased from 39 psi to 33 psi, system temperature increased from 11 C to 27 C, and system flow rate increased from 55 to 69 l/min.

Visual examination through a clear Plexiglas cover on the milling chamber indicated high speed vortex flow of the media and sucrose solution mixture, confirming the development of a high-energy milling condition.

Following completion of media feed to the milling chamber, the process was stopped and the media safety screen was disassembled to measure the amount of media that escaped the mill. It was found that <1 cc of media escaped the mill during this example, indicating good media retention within the mill.

What is claimed:

1. A fluid energy media mill comprising:
at least one hollow milling chamber 101 having a top 108, a bottom 118, and a side wall 114, milling media disposed in the hollow milling chamber 101, the milling chamber 101 has at least one inlet 102 along the side wall 114, the inlet 102 configured to introduce the material into the hollow milling chamber 101 and promote a flow of the material and milling medium in the hollow milling chamber 101, and an outlet 103 connected to the hollow milling chamber 101; and
a pump 104 in fluid communication with the inlet 102 for introducing material through the hollow milling chamber 101.

2. The mill of claim 1, wherein the outlet 103 is axially disposed on the top 108 of hollow milling chamber 101.

3. The mill of claim 1, wherein the inlet 102 is disposed substantially tangential to the side wall 114 of the hollow milling chamber 101, whereby material introduced by the inlet 102 has a material inlet flow path 205 substantially parallel to an inner wall 201 of the hollow milling chamber 101.

4. The mill of claim 1, wherein the inlet 102 has a first end having a first diameter, and a second end having a second diameter different than the first end diameter, the second end diameter in fluid communication with the milling chamber interior 204.

5. The mill of claim 1, wherein the axially disposed outlet 103 is an outlet conduit 107 having one end extending into the milling chamber interior 204 and having a screen 112 releasably mounted thereto to prevent the escape of milling medium from the hollow milling chamber 101, the other end of outlet conduit 107 is coupled to the pump 104.

6. The mill of claim 1, wherein the axially disposed outlet 103 is an outlet conduit 107 having one end extending into the milling chamber interior 204 and having a vortex finder 501 mounted thereto, the other end of the outlet conduit 107 coupled to the pump 104.

7. The mill of claim 1, wherein the milling chamber interior 204 is defined by a cylindrical wall.

8. The mill of claim 1, wherein the milling medium are small bodies of a material selected from the group consisting of ceramic, metallic, glass, and polymeric.

9. The mill of claim 8, wherein the small bodies have a size selected from the group consisting of less than 10,000, less than 5,000, less than 2000, less than 1000, less than 500, less than 250, less than 100, less than 50, less than 25, less than 5 microns in average diameter.

10. The mill of claim 1 further comprising a second inlet 302 disposed along a side wall 114 of the hollow milling chamber 101.

11. The mill of claim 10, wherein the second inlet 302 is disposed along a side wall 114 of the hollow milling chamber 101 at a distance from inlet 102, and configured to promote a vortex of the material and milling medium when introduced into the hollow milling chamber 101.

12. The mill of claim 11, wherein the second inlet 302 is disposed substantially tangential to the side wall 114 of the hollow milling chamber 101, whereby material and milling medium introduced by the second inlet 302 has a flow path 205 substantially parallel to an inner wall 201 of the hollow milling chamber 101.

13. The mill of claim 10, wherein the at least one inlet 102 and the second inlet 302 are disposed along the same radial plane of the hollow milling chamber 101.

14. The mill of claim 1, comprising at least four inlets, the first two disposed along the same radial plane of the hollow milling chamber 101 and the second two disposed along the same radial plane but at a different location than the first two inlets.

15. The mill of claim 1, further comprising a milling medium reservoir.

16. The mill of claim 1, further comprising a heat exchanger for cooling and heating the flow of material through the fluid energy media mill.

17. A method of milling a material comprising:
feeding a fluidized material into a hollow milling chamber via an inlet disposed substantially tangential to an interior wall of the hollow milling chamber;
introducing a generally tangential flow of the fluid material along an interior wall of the hollow milling chamber to create a vortex flow therein;
impacting the fluidized material against milling media contained in the hollow milling chamber thereby milling the material into small particles; and
extracting the fluidized material from an axially disposed outlet of the hollow milling chamber while the milling media remains substantially within the hollow milling chamber

18. The method of claim 17 further comprising the step of recirculating, via a pump, the extracted fluidized material and reintroducing the fluidized material into the hollow milling chamber to affect the milling of the material.
